(19) United States
(12) Patent Application Publication
(10) Pub. No.: US 2006/0159853 A1
(43) Pub. Date: Jul. 20, 2006

(54) Surface coating method of sulphide phosphor and surface coated sulphide phosphor

(75) Inventors: Yun Seup Chung, Seoul (KR); Chul Soo Yoon, Suwon (KR); Jong Rak Sohn, Suwon (KR); Chang Hoon Kwak, Seoul (KR)

Correspondence Address: MCDERMOTT WILL & EMERY LLP, 600 13TH STREET, N.W., WASHINGTON, DC, 20005-3096, US

(73) Assignee: SAMSUNG ELECTRO-MECHANICS CO., LTD.

(21) Appl. No.: 11/322,257

(22) Filed: Jan. 3, 2006

(30) Foreign Application Priority Data
Jan. 3, 2005 (KR) 10-2005-000264
Dec. 21, 2005 (KR) 10-2005-127365

(51) Int. Cl. B07B 13/00; B41M 5/20; H01M 4/02

(52) U.S. Cl. 427/304; 209/49; 118/623; 205/50

(57) ABSTRACT

The present invention relates to a surface coating method of a sulphide phosphor and thereby coated sulphide phosphor. The surface coating method includes preparing sulphide phosphor powder, applying silane modifier to the sulphide phosphor to form an organic polymer film containing silicon on the surface of the sulphide phosphor. The method further includes heat-treating the sulphide phosphor powder to obtain a silicon oxide film from the organic polymer film.

### CLAIM OF PRIORITY

This application claims the benefit of Korean Patent Applications No. 2005-127365 filed on Dec. 21, 2005 and No. 2005-264 filed on Jan. 3, 2005, in the Korean Intellectual Property Office, the disclosure of which is incorporated herein by reference.

### BACKGROUND OF THE INVENTION

1. Field of the Invention

The present invention relates to a fabrication method of phosphor for wavelength conversion and surface coating phosphor. More particularly, the invention relates to a surface coating method of a sulphide phosphor and surface coated sulphide phosphor which can block reaction with curing catalyst while maintaining optical properties.

2. Description of the Related Art

In general, a phosphor for wavelength conversion is used for converting a specific wavelength light of various light sources into a desired wavelength light. Among the various light sources, Light Emitting Diode (LED) is positively applied to Lucid Crystal Display (LCD) backlights, automobile and home illumination since it can be driven by low power, having superior light efficiency. Therefore, the phosphor has been popularized as a core technology for manufacturing white LEDs.

In general, a white light emitting device can be realized through a combination of a blue LED and a yellow phosphor, a combination of a blue LED with green and red phosphors, and a combination of an ultraviolet LED with a mixture of red, green and blue phosphors. Of these combinations, it has been known that the combination of the ultraviolet LED with the mixture of red R, green G, and blue B phosphors results in a white light emitting device possessing the most superior white light characteristics closest to natural light.

In the meantime, an oxide red phosphor has low luminance and a narrow color distribution compared with other green or blue phosphors. Thus, when the oxide red phosphor is used for the red phosphor of the RGB phosphor mixture, luminance and color rendering index of the resultant white light emitting device are adversely affected as well.

As an advanced approach from using the oxide-based phosphor having such demerits, using a sulphide phosphor instead has been considered an option. The sulphide phosphor has higher luminance and a broad color distribution compared with the oxide phosphor, and thus superior optical characteristics can be expected. For example, as shown in FIG. 1, an europium-doped strontium sulphide (SrS:Eu) b, a sulphide phosphor, has about 36% higher luminance, capable of converting into a light having wavelength band 2.5 to 4 times broader compared with an europium-doped gadolinium oxide (Gd₂O₃:Eu) a.

However, despite the superior optical characteristics, the sulphide phosphor has a problem of instability that its structure is easily collapsed by external energy. Further, when the sulphide phosphor is mixed with polymer curing agent such as silicon or epoxy resin to be cured with Pt added as a curing catalyst, the sulphide phosphor reacts with Pt, resulting in a serious problem that curing does not take place.

In the prior art, in order to solve such a problem, high-temperature (about 600° C.) heat treatment was conducted before mixing the sulphide phosphor powder with the polymer curing agent to form an oxide film. Nonetheless, the reaction with Pt could not be adequately suppressed and some portions of the molding remain uncured or bubbles may be produced from the heat-treated phosphor, degrading the phosphor characteristics. Further, the phosphor particles severely cohere with one another, hindering even dispersion within the polymer curing agent.

### SUMMARY OF THE INVENTION

The present invention has been made to solve the foregoing problems of the prior art and it is therefore an object of the present invention to provide a surface coating method of a sulphide phosphor in which a protective film is formed on the sulphide phosphor for physical and chemical stability without changing its optical characteristics.

It is another object of the invention to provide a sulphide phosphor, which is not easily changed in its optical characteristics, having superior physical and chemical stability.

According to an aspect of the invention for realizing the object, there is provided a surface coating method of a sulphide phosphor including steps of: preparing sulphide phosphor powder; applying silane modifier to the sulphide phosphor to form an organic polymer film containing silicon on the surface of the sulphide phosphor; and heat-treating the sulphide phosphor powder to obtain a silicon oxide film from the organic polymer film.

In the step of heat treatment, a buffer film containing sulfur and hydrocarbon groups may be obtained between the silicon oxide film and the sulphide phosphor. The hydrocarbon group may comprise alkyl group.

The sulphide phosphor may include sulphide selected from a group consisting of strontium sulphide (SrS), calcium sulphide (CaS), cadmium sulphide (CdS), zinc sulphide (ZnS), strontium thiogallate (SrGa₂S₄) and combinations thereof. The sulphide phosphor may be doped with at least one selected from a group consisting of Eu, Tb, Sm, Pr, Dy and Tm.

The silane modifier may include silane selected from a group consisting of alkyl silane, alcoxy silane, methyl silane, methoxysilane, hydroxyl silane and combinations thereof. Preferably, the silane modifier may include mercapto group silane modifier. Particularly, the silane modifier may be 3 (mercaptopropyl) trimethoxysilane (TMS, Si(CH₃O)₃(CH₂)₃SH).

Preferably, the step of forming an organic polymer film may comprise liquid-state coating the sulphide phosphor with the silane modifier. In this case, it is preferable that the step of liquid-state coating is conducted in an alcoholic atmosphere to prevent oxidation of the sulphide phosphor. Further, ammonia (NH₄OH) may be added as a reaction catalyst in the alcoholic atmosphere in the liquid-state coating to accelerate formation of the organic polymer film.

There may be differences depending on the types of modifiers and coating processes, but it is preferable that the applied silane modifier is 0.1 to 3 wt % of the sulphide phosphor powder. If the amount of the applied silane modifier is less than 0.1 wt % of the sulphide phosphor powder, sufficient coating effect cannot be expected, and if the amount is more than 3 wt % of the sulphide phosphor powder, the thickness of the coating becomes too big, which may undermine luminance characteristics related to the phosphor powder. According to a specific condition, it is preferable that the applied silane modifier is 0.2 to 2 wt % of the sulphide phosphor powder.

Preferably, the step of heat treatment may be conducted in the temperature ranging from about 200 to 600° C. As the organic component is removed, it is preferable that the silicon oxide film is formed at a temperature at least 200° C., but if the temperature exceeds 600° C., the characteristics of the phosphor powder may be undermined.

In addition, the present invention provides a surface coated sulphide phosphor coated by the surface coating method described above.

According to another aspect of the invention for realizing the object, there is provided a surface coated sulphide phosphor including: a sulphide phosphor; a silicon oxide film formed on the sulphide phosphor; and a buffer layer containing sulfur and hydrocarbon groups, formed between the sulphide phosphor and the silicon oxide film. According to an embodiment of the invention, the hydrocarbon group may comprise alkyl group.

According to an embodiment of the present invention, the sulphide phosphor may include sulphide selected from a group consisting of strontium sulphide (SrS), calcium sulphide (CaS), cadmium sulphide (CdS), zinc sulphide (ZnS), strontium thiogallate (SrGa₂S₄) and combinations thereof. Also, the sulphide phosphor may be doped with at least one selected from a group consisting of Eu, Tb, Sm, Pr, Dy and Tm. Particularly, the sulphide phosphor may be an Eu-doped phosphor.

According to an embodiment of the invention, the sulphide phosphor may be red or green phosphor. The red sulphide phosphor may be europium-doped sulphide (SrS:Eu) or europium-doped calcium sulphide (CaS:Eu). The green sulphide phosphor may be europium-doped strontium thiogallate (SrGa₂S₄:Eu)

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a graph illustrating light emission spectrums of an oxide red phosphor and a sulphide red phosphor of the prior art;

FIG. 2 is a schematic diagram for explaining a surface coating method according to the present invention;

FIGS. 3a and 3b are Scanning Electron Microscopy (SEM) pictures of a sulphide phosphor taken before and after being applied with a silane modifier, respectively, according to the present invention;

FIG. 4 is a schematic diagram for explaining the surface coating method of the phosphor according to the present invention;

FIGS. 5a and 5b are plan views of upper parts of Light Emitting Diode (LED) packages having a prior art sulphide red phosphor and a surface coated sulphide red phosphor of the present invention, respectively;

FIG. 6 is a graph illustrating changes in luminance characteristics according to changes in the amount of the silane modifier in the surface coating method of the present invention;

FIG. 7 is a graph illustrating changes in luminance characteristics according to the temperature changes in heat treatment for forming an oxide film in the surface coating method of the phosphor according to the present invention;

FIG. 8 is a Transmission Electron Microscopy (TEM) picture of the surface of the sulphide phosphor taken before being coated with the silane modifier according to the present invention;

FIG. 9 is a TEM picture of the surface of the sulphide phosphor taken after being coated with the silane modifier according to the present invention;

FIGS. 10a and 10b are graphs showing the results of reliability evaluation of LED packages using prior art phosphor; and

FIGS. 11a and 11b are graphs showing the results of reliability evaluation of LED packages using surface coated phosphor of the invention.

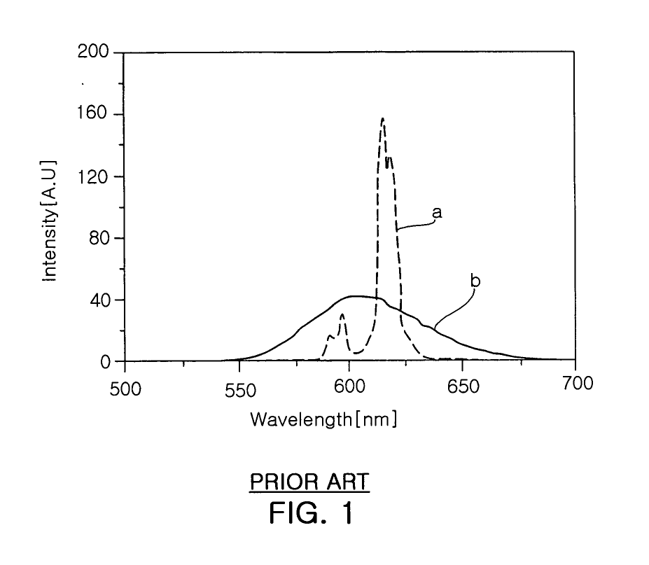

### DETAILED DESCRIPTION OF THE PREFERRED EMBODIMENT

Preferred embodiments of the present invention will now be described in detail with reference to the accompanying drawings.

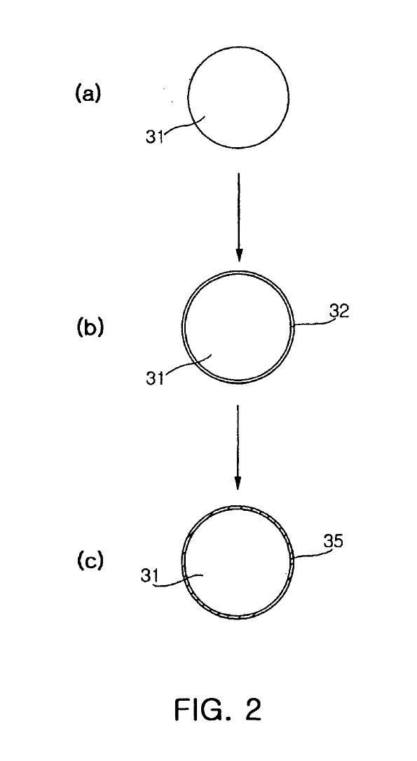

FIG. 2 is a schematic diagram illustrating a surface coating method of a phosphor according to the present invention.

The surface coating method of a sulphide phosphor according to the present invention starts with a step of preparing sulphide phosphor powder. The sulphide phosphor applicable to the present invention includes sulphide selected from a group consisting of strontium sulphide (SrS), calcium sulphide (CaS), cadmium sulphide (CdS), zinc sulphide (ZnS), strontium thiogallate sulphide (SrGa₂S₄) and combinations thereof, and may be sulphide phosphor doped with at least one selected from a group consisting of Eu, Tb, Sm, Pr, Dy and Tm.

In order for clearer explanation of the invention, FIG. 2(a) roughly illustrates a particle 31 of the sulphide phosphor.

Next, a silane modifier is applied on the sulphide phosphor powder to form an organic polymer film. Unlike other modifiers, a mercapto group silane modifier has “—SH” at the end of the functional group, which reacts with sulfur of the surface of the sulphide phosphor, maintaining stable binding to form an organic polymer film 32 on the surface of the phosphor particle 31 as shown in FIG. 2(b). Various structures of the organic polymer film can be provided depending on the different types of the silane modifier.

The silane modifier adopted in the present invention may use, but is not limited to, modifiers containing silane selected from a group consisting of alkyl silane, alcoxy silane, methyl silane, methoxysilane, hydroxyl silane and combinations thereof, and which can react and bind with the sulfur on the surface of the phosphor. The coating process of the organic polymer film can preferably be conducted via liquid-state coating.

The organic polymer film formed with the silane modifier is hydrophobic and thus can prevent natural oxidization, but cannot effectively suppress reaction to Pt, a curing catalyst. Therefore, a heat treatment is required to obtain a silicon oxide film 35 from the organic polymer film 32 as shown in FIG. 2(c). Through such a heat treatment, a silicon oxide film 35 with tightly bound with the entire surface of the phosphor can be formed when applied to an LED. The silicon oxide film 35 can act as a protective surface of the sulphide phosphor particle 31, effectively blocking reaction with Pt, the curing catalyst, in the process of curing. Moreover, in an alternative embodiment, a thin buffer film containing sulfer (S) and hydrocarbon group can be formed between the silicon oxide film 35 and the phosphor 31.

Depending on the types of organic polymer films and other conditions of the process, the conditions for the heat treatment can vary but can be set within an appropriate range that allows formation of silicon oxide film on the surface of the sulphide phosphor. Preferably, the heat treatment can effectively be conducted at a temperature at least about 200° C., but an extremely high temperature can degrade the phosphor characteristics, and thus preferably can be conducted at a temperature up to 600° C.

Now, the present invention will be explained in more detail through specific examples.

### EXAMPLE 1

A red phosphor of europium-doped strontium sulphide (SrS:Eu) of sulphide phosphor was prepared. The red sulphide phosphor powder was liquid-state coated with 1 wt % of 3(mercaptopropyl)trimethoxysilane (TMS, Si(CH₃O)₃(CH₂)₃SH), which is a mercapto group silane modifier, to form an organic polymer film thereon. The liquid-state coating was conducted in an alcoholic atmosphere with a small amount of ammonia added as a reaction catalyst.

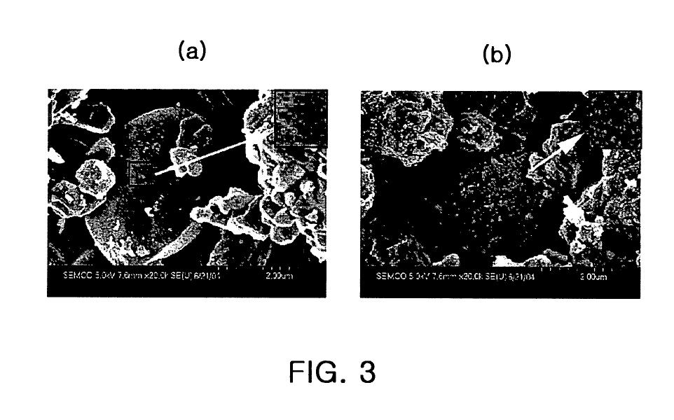

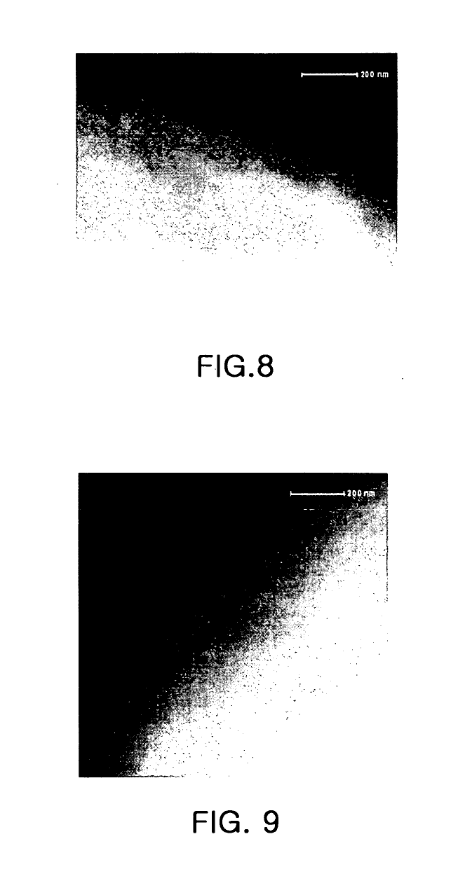

FIGS. 3a and 3b are SEM pictures of the red phosphor powder taken before and after being coated with the silane modifier according to this embodiment. With reference to FIG. 3a, unlike a phosphor particle having smooth surface, the phosphor particle has an organic polymer film formed on the surface thereof after the liquid-state coating. The surface of the phosphor particle before and after the liquid-state coating is more closely shown in FIGS. 8 and 9. FIGS. 8 and 9 are TEM pictures showing the surface of the phosphor before and after the liquid-state coating as described above. As shown in FIG. 9, it is clearly noticeable that a TMS film is coated on the surface of the phosphor particle.

Next, the red phosphor powder with the organic polymer film formed thereon was heat-treated at about 300° C. for one hour. In this heat treatment, a silicon oxide film was formed from the organic polymer film. During this process, a buffer film containing sulfur (S) and alkyl group (e.g. ethyl group) was formed between the SrS:Eu phosphor and the silicon oxide film. The silicon oxide film is more strongly bound with the SrS:Eu phosphor by this buffer film, thereby decreasing the chances of degradation due to external environment (water or heat).

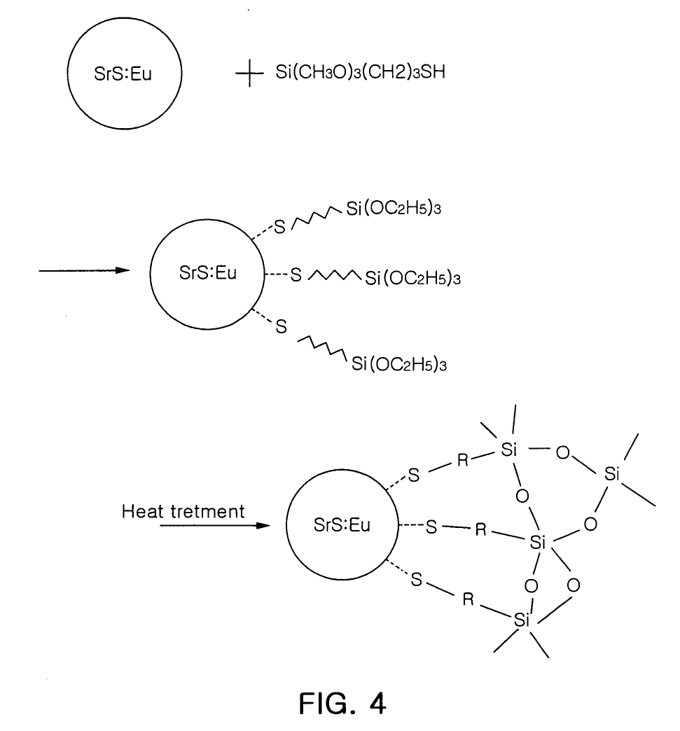

The process of this example is more easily understood by the chemical reaction process shown in FIG. 4.

With reference to FIG. 4, when europium-doped strontium sulphide (SrS:Eu) and 3 (mercaptopropyl)trimethoxysilane (TMS) react to each other, the sulfur (S) on the surface of the SrS:Eu particle binds with SH of TMS, forming an organic polymer film of Si(OC₂H₅)₃ on the surface of the SrS:Eu particle. Thereafter, via a heat treatment, a buffer film (S—R) containing sulfur (S) and alkyl group (R) along with a silicon oxide film (SiO₂) bound strongly with this buffer film is formed on the surface of the SrS:Eu particle. Thereby, the surface coated red sulphide phosphor is obtained from this example. The silicon oxide film (SiO₂) acts as a protective film blocking reaction with Pt in the curing process, allowing complete curing.

### EXAMPLE 2

This example was conducted to observe curing characteristics of a white light emitting device package, which is applied with the present invention.

First, a conventional example of an europium-doped strontium sulphide (SrS:Eu) was heat-treated (at 500° C., for 1 hour) only without being coated with silane modifier.

On the other hand, as an inventive example, a silicon oxide film was formed on the surface of the europium-doped strontium sulphide (SrS:Eu) in the same conditions as in the Example 1, and the heat treatment was conducted at about 500° C. for 1 hour.

The red phosphor powder obtained for the conventional example and the surface coated red phosphor powder obtained for the inventive example were mixed with a silicon polymer resin and then with Pt, the curing catalyst, respectively, under the same conditions. Then, the mixtures were put into the same LED packages and formed into the wave-conversion molding parts under the same curing conditions.

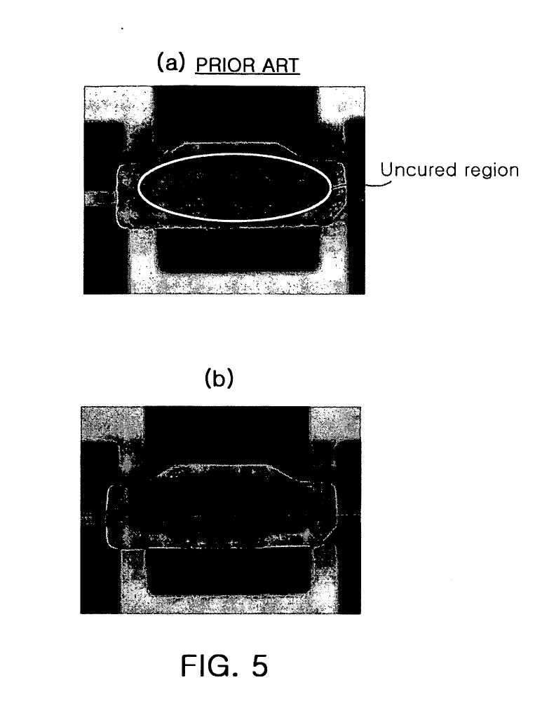

FIGS. 5a and 5b are plan views of the upper parts of the LED packages manufactured using the sulphide phosphor obtained from the above described processes of the conventional example and the inventive example, respectively.

With reference to FIG. 5a, in the wavelength molding part of the LED package of the conventional sample, it was noticeable that a considerably large portion was not cured. On the other hand, it was noticeable that curing was complete in all portions in the inventive example under the same curing conditions.

In the case of forming an oxide film via only heat treatment as in the conventional example, the reaction of the phosphor with Pt was not adequately suppressed. But in the inventive example, the silane modifier was used to form the organic polymer film, from which a silicon oxide film was obtained, thereby effectively suppressing reaction with Pt and greatly improving curability.

### EXAMPLE 3

This example was conducted to find more desirable conditions of the surface coating method.

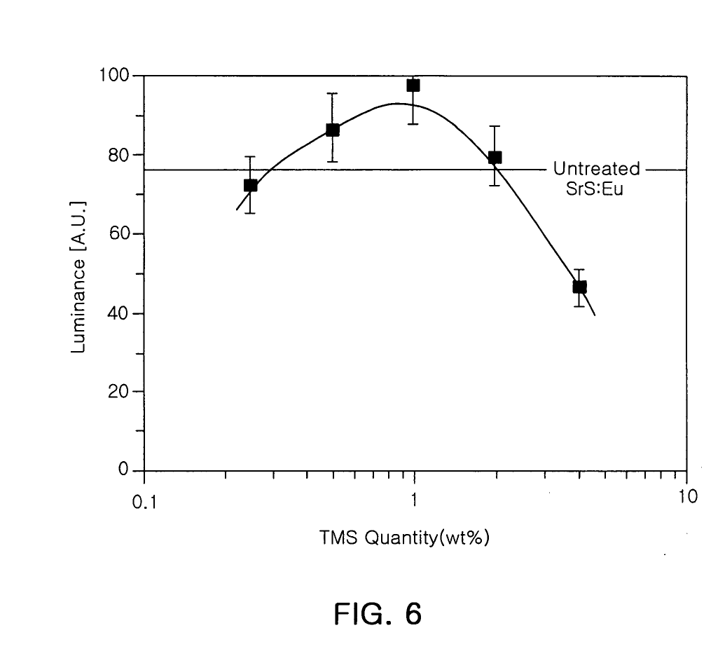

The same material and conditions as in the Example 1 were applied to produce red phosphor powder samples except that the amount of TMS used in the liquid-state coating was varied from 0.1 wt % to 3 wt % based on the weight of the red phosphor powder. The luminance was measured from the obtained red phosphor powder samples, and the results are shown in FIG. 6.

In the graph of FIG. 6, the changes in luminance according to varying weight of the TMS in the TMS-applied samples are shown in comparison to the red phosphor powder (SrS:Eu) which is not coated with TMS. The values were marked with the vertical axis as the luminance of the pure red phosphor powder set at 100%.

Referring to FIG. 6, it can be confirmed that the red phosphor surface-treated with 0.2 to 2 wt % of TMS exhibits characteristics improved (about 78%) from the conventional phosphor, and the red phosphor surface-treated with about 1 wt % of TMS exhibits high luminance of almost 98%. The above weight range does not limit the present invention but is preferable since the phosphor exhibits superior luminance in the range of 0.2 to 2 wt % of TMS compared with the conventional example.

However, this may vary somewhat depending on the kind of material and the fineness of the phosphor powder. As shown in FIG. 6, if the weight of TMS exceeds 3 wt %, the thickness of the coated silicon oxide film becomes too big and the level of luminance becomes lower. Still, the larger weight of TMS is more advantageous in stabilizing the characteristics of the SrS:Eu phosphor.

### EXAMPLE 4

In this example, after the coating with the silane modifier, the changes in luminance due to the heat treatment were observed.

First, red phosphor powder (SrS:Eu) was produced with the same material and under the same conditions as in Example 1, except that the temperature of the subsequent heat treatment was varied from 20° C. to 600° C. In addition, red phosphor powder that was not coated with the silane modifier was heat-treated at each temperature.

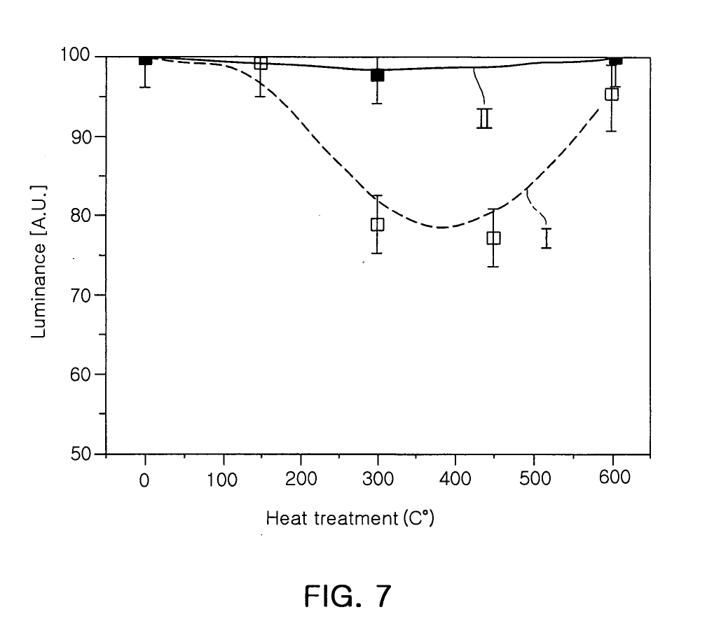

The luminance was measured from each red phosphor powder, and the results are shown in a graph in FIG. 7.

The conventional red phosphor powder I that was not coated with the silane modifier showed rapid deterioration of the luminance in the temperature ranging from about 150° C. to 600° C. On the other hand, the red phosphor powder II coated with the silane modifier and then heat-treated did not exhibit degradation in the luminance characteristics according to the change in the temperature, which confirms that the optical characteristics are not undermined by the heat treatment in the present invention.

However, if the temperature of the heat treatment is 200° C. or below, a longer period of time is required for the heat treatment or it may be difficult to transform the organic polymer film into the silicon oxide film whereas if the temperature exceeds 600° C., the phosphor characteristics can be degraded. Therefore, it is preferable to conduct the heat treatment in the temperature ranging from 200 to 600° C.

### EXAMPLE 5

This example was conducted to confirm the reliability of the LED package fabricated with the surface coated sulphide phosphor of the present invention.

First, as conventional samples, a CaS:Eu red phosphor, a SrGa₂S₄ green phosphor and a blue LED were used to prepare LED packages. The CaS:Eu phosphor and SrGa₂S₄ phosphor of the conventional samples were not surface coated according to the present invention.

On the other hand, as inventive samples, a CaS:Eu red phosphor and a SrGa₂S₄ green phosphor were surface coated under the same conditions (liquid-state coating with 1 wt % of TMS, heat treatment at 300° C. for 1 hour) as in Example 1 to form silicon oxide films on the surfaces of the phosphors. The surface coated red and green phosphors were combined with a blue LED to prepare LED packages.

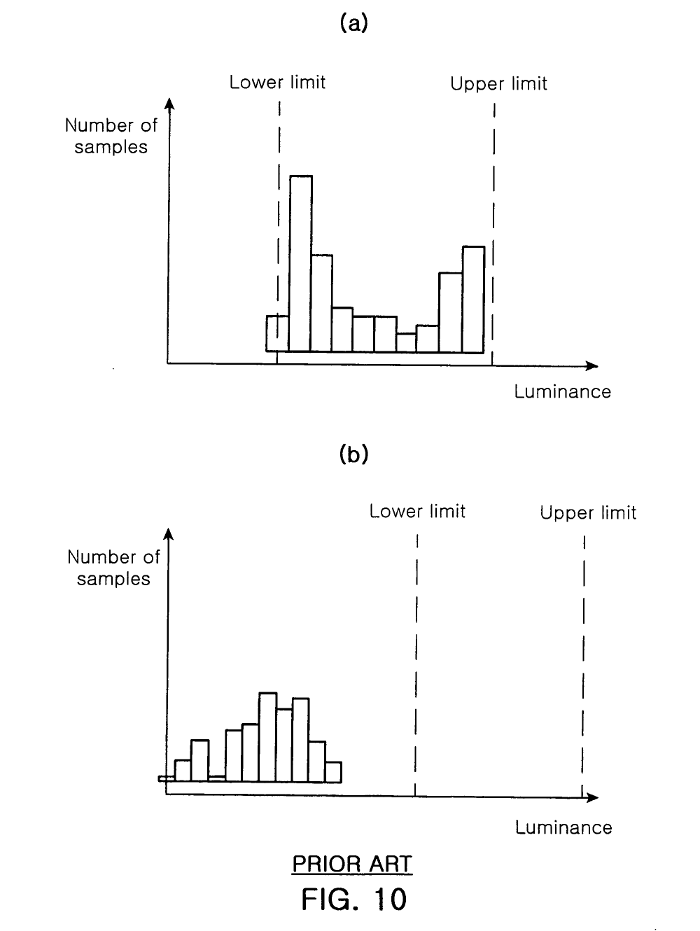

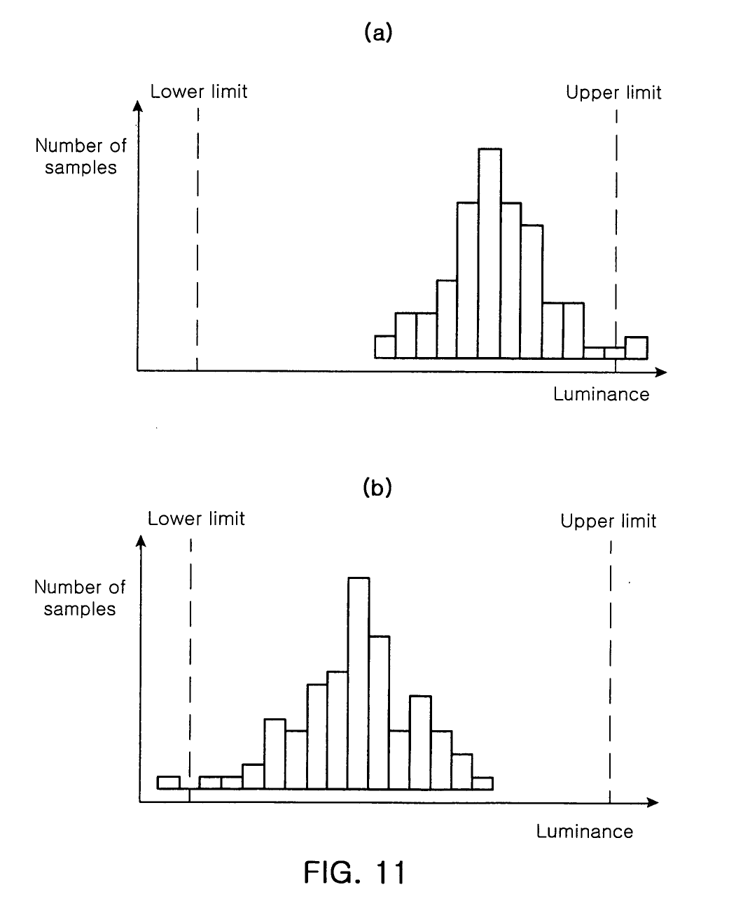

Each LED package sample prepared was evaluated in its reliability in an experiment under the condition of the same high temperature and humidity conditions, and the results are shown in FIGS. 10 and 11. For the reliability experiment, the LEDs were operated in the high humidity and temperature condition, i.e., at a relative humidity of 85% and a temperature of 85° C. for 24 hours. The luminance of each sample was measured before and after the experiment in the high humidity and temperature condition.

FIGS. 10a and 10b are graphs showing the luminance distributions of the conventional samples before and after the experiment in high humidity and temperature condition. As shown in FIG. 10a, before the experiment, most of the conventional samples met the luminance level required for the product. That is, there was no sample that deviated from the range of the maximum and minimum values of luminance. However, after the experiment, all samples exhibited lower luminance than the minimum required luminance, deviating from the range of luminance requirement.

FIGS. 11a and 11b are graphs showing the luminance distributions of the inventive samples before and after the experiment in high humidity and temperature condition. As shown in FIGS. 11a and 11b, even after the evaluation in high humidity and temperature condition, almost all samples met the level of luminance requirement. Therefore, it was shown through this example that the reliability of the LED package was improved greatly by the surface coating of the sulphide phosphor.

The examples were described mainly on the specific red sulphide phosphor and silane modifier but they do not limit the present invention. All sulphide phosphors are applicable to the present invention, and all modifiers that react with sulphide phosphor to form organic polymer film, forming silicon oxide film via heat treatment are usable in the present invention.

As set forth above, the surface coated sulphide phosphor according to the present invention has high physical and chemical stability without being changed in the optical characteristics. Thereby, the present invention is able to suppress the reaction with Pt in the curing process without incurring change in luminance, allowing manufacturing of high quality white light emitting device packages.

Furthermore, the surface coating method according to the present invention provides a practical approach to replacing the oxide-based phosphor with highly reliable sulphide phosphor having superior luminance and color distribution characteristics.

While the present invention has been shown and described in connection with the preferred embodiments, it will be apparent to those skilled in the art that modifications, variations, changes and substitutions can be made without departing from the spirit and scope of the invention as defined by the appended claims.

What is claimed is:

1. A surface coating method of a sulphide phosphor comprising steps of:
preparing sulphide phosphor powder;
applying silane modifier to the sulphide phosphor to form an organic polymer film containing silicon on the surface of the sulphide phosphor; and
heat-treating the sulphide phosphor powder to obtain a silicon oxide film from the organic polymer film.

2. The surface coating method of a sulphide phosphor according to claim 1, wherein the step of heat treatment comprises forming a buffer film containing sulfur and hydrocarbon groups between the silicon oxide film and the sulphide phosphor.

3. The surface coating method of a sulphide phosphor according to claim 2, wherein the hydrocarbon group comprises alkyl group.

4. The surface coating method of a sulphide phosphor according to claim 1, wherein the sulphide phosphor includes sulphide selected from a group consisting of strontium sulphide (SrS), calcium sulphide (CaS), cadmium sulphide (CdS), zinc sulphide (ZnS), strontium thiogallate (SrGa₂S₄) and combinations thereof.

5. The surface coating method of a sulphide phosphor according to claim 1, wherein the sulphide phosphor is doped with at least one selected from a group consisting of Eu, Tb, Sm, Pr, Dy and Tm.

6. The surface coating method of a sulphide phosphor according to claim 1, wherein the silane modifier comprises mercapto group silane modifier.

7. The surface coating method of a sulphide phosphor according to claim 6, wherein the mercapto group silane modifier comprises 3(mercaptopropyl)trimethoxysilane (TMS, Si(CH₃O)₃(CH₂)₃SH).

8. The surface coating method of a sulphide phosphor according to claim 1, wherein the silane modifier comprises silane selected from a group consisting of alkyl silane, alcoxy silane, methyl silane, methoxysilane, hydroxyl silane and combinations thereof.

9. The surface coating method of a sulphide phosphor according to claim 1, wherein the step of forming organic polymer film comprises liquid-state coating the sulphide phosphor with the silane modifier.

10. The surface coating method of a sulphide phosphor according to claim 9, wherein the step of liquid-state coating is conducted in an alcoholic atmosphere.

11. The surface coating method of a sulphide phosphor according to claim 10, wherein ammonia (NH₄OH) is added as a reaction catalyst in the alcoholic atmosphere in the liquid-state coating.

12. The surface coating method of a sulphide phosphor according to claim 1, wherein the applied silane modifier is 0.1 to 3 wt % of the sulphide phosphor powder.

13. The surface coating method of a sulphide phosphor according to claim 1, wherein the applied silane modifier is 0.2 to 2 wt % of the sulphide phosphor powder.

14. The surface coating method of a sulphide phosphor according to claim 1, wherein the step of heat treatment is conducted in the temperature ranging 200 to 600° C.

15. A surface coated sulphide phosphor which is coated with a silicon oxide film by the surface coating method of claim 1.

16. A surface coated sulphide phosphor comprising:
a sulphide phosphor;
a silicon oxide film formed on the sulphide phosphor; and
a buffer layer containing sulfur and hydrocarbon groups, formed between the sulphide phosphor and the silicon oxide film.

17. The surface coated sulphide phosphor according to claim 16, wherein the hydrocarbon group comprises alkyl group.

18. The surface coated sulphide phosphor according to claim 16, wherein the sulphide phosphor includes sulphide selected from a group consisting of strontium sulphide (SrS), calcium sulphide (CaS), cadmium sulphide (CdS), zinc sulphide (ZnS), strontium thiogallate (SrGa₂S₄) and combinations thereof.

19. The surface coated sulphide phosphor according to claim 16, wherein the sulphide phosphor is doped with at least one selected from a group consisting of Eu, Tb, Sm, Pr, Dy and Tm.

20. The surface coated sulphide phosphor according to claim 16, wherein the sulphide phosphor includes SrS:Eu or CaS:Eu.

21. The surface coated sulphide phosphor according to claim 16, wherein the sulphide phosphor includes SrGa₂S₄:Eu.
